(19) United States
(12) Patent Application Publication
(10) Pub. No.: US 2013/0198203 A1
(43) Pub. Date: Aug. 1, 2013

(54) Bot detection using profile-based filtration

(71) Applicants: John Bates, Springville, UT (US); Ben S. Robison, Lehi, UT (US)

(72) Inventors: John Bates, Springville, UT (US); Ben S. Robison, Lehi, UT (US)

(21) Appl. No.: 13/335,710

(22) Filed: Dec. 22, 2011

(51) Int. Cl. G06F 17/30

(52) U.S. Cl. 707/748; 707/E17.084

(57) ABSTRACT

Methods and apparatus for bot detection using profile based filtration are disclosed. A statistical profile describing attributes of automated-origin content request activity for a network content provider is built. A plurality of content requests of unknown origin in terms of similarity to the attributes is scored. A likelihood of automated-origin content request activity based on the scoring is indicated.

### BACKGROUND

### Description of the Related Art

Goods and services providers often employ various forms of marketing to drive consumer demand for products and services. Marketing includes various techniques to expose to target audiences to brands, products, services, and so forth. For example, marketing often includes providing promotions (e.g., advertisements) to an audience to encourage them to purchase a product or service. In some instances, promotions are provided through media outlets, such as television, radio, and the internet via television commercials, radio commercials and webpage advertisements. In the context of websites, marketing may provide advertisements for a website and products associated therewith to encourage persons to visit the website, use the website, purchase products and services offered via the website, or otherwise interact with the website.

Marketing promotions often require a large financial investment. A business may fund an advertisement campaign with the expectation that increases in revenue attributable to marketing promotions exceed the associated cost. A marketing campaign may be considered effective if it creates enough interest and/or revenue to offset the associated cost. Accordingly, marketers often desire to track the effectiveness of their marketing techniques generally, as well as the effectiveness of specific promotions. For example, a marketer may desire to know how many customers purchased a product as a result of a particular placement of an ad in a website.

In the context of internet advertising, tracking user interaction with a website is known as “web analytics.” Web analytics is the measurement, collection, analysis and reporting of internet data for purposes of understanding and optimizing web usage. Web analytics provides information about the number of visitors to a website and the number of page views, as well as providing information about the behavior of users while they are viewing the site.

Internet bots, also known as web robots, WWW robots or simply bots, are software applications that run automated tasks over the Internet. Typically, bots perform tasks that are both simple and structurally repetitive, at a much higher rate than would be possible for a human alone. The largest use of bots is in web spidering, in which an automated script fetches, analyzes and files information from web servers at many times the speed of a human. Traffic from bots reduces the usefulness of analytics in providing information about the number of visitors to a website and the number of page views, as well as providing information about the behavior of users while they are viewing the site.

### SUMMARY

Methods and apparatus for bot detection using profile based filtration are disclosed. A statistical profile describing attributes of automated-origin content request activity for a network content provider is built. A plurality of content requests of unknown origin is scored in terms of similarity to the attributes. A likelihood of automated-origin content request activity based on the scoring is indicated.

### BRIEF DESCRIPTION OF THE DRAWINGS

FIG. 1 illustrates an example network content analytics system configured to support bot detection using profile-based filtration in accordance with one or more embodiments.

FIG. 2 depicts a module that may implement bot detection using profile-based filtration, according to some embodiments.

FIG. 3 illustrates a high-level logical flowchart of operations performed to implement one embodiment of bot detection using profile-based filtration.

FIG. 4A depicts a high-level logical flowchart of run-time operations performed to implement one embodiment of bot detection using profile-based filtration.

FIG. 4B illustrates a high-level logical flowchart of runtime operations performed to implement one embodiment of bot detection using list and profile-based filtration.

FIG. 5 depicts a high-level logical flowchart of operations performed to implement one embodiment of processing of network analytics using profile-based filtration.

FIG. 6 illustrates a high-level logical flowchart of operations performed to implement one embodiment of bot detection using list and profile-based filtration.

FIG. 7 depicts a high-level logical flowchart of operations performed to implement a process flow for bot detection using profile-based filtration.

FIG. 8 illustrates a high-level logical flowchart of operations performed to implement a process flow for bot detection using profile-based filtration, according to some embodiments.

FIG. 9 depicts a high-level logical flowchart of operations performed to implement a process flow for bot detection using profile-based filtration, according to some embodiments.

FIG. 10 depicts an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art.

An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Introduction to Bot Detection Using Profile-Based Filtration

Various embodiments of methods and apparatus for bot detection using profile-based filtration are described below in the example context of use in network analytics. Some embodiments support building a statistical profile describing attributes of automated-origin content request activity for a network content provider. In some embodiments, a plurality of content requests of unknown origin is scored in terms of similarity to the attributes, and a likelihood of automated-origin content request activity based on the scoring is indicated.

Some embodiments additionally support filtering the plurality of content requests of unknown origin to eliminate ones of the plurality of content requests of unknown origin arriving from a list of known automated sources. In some embodiments, the building the statistical profile of attributes of automated content request activity further includes generating the attributes of automated-origin content request activity by characterizing a plurality of content requests arriving from a list of known automated sources. Additionally, in some embodiments, the building the statistical profile of attributes of automated content request activity further includes generating the attributes of automated-origin content request activity by characterizing a plurality of content requests arriving from a list of known automated sources based on common attributes. In some embodiments, the building the statistical profile of attributes of automated content request activity further includes generating the attributes of automated-origin content request activity by characterizing a plurality of content requests arriving from a list of known automated sources for attributes dissimilar from attributes of known non-automated content request activity.

Some embodiments further support generating analytics reports describing features of the sample of the content requests selected as having the low likelihood of automated-origin content request activity based on the scoring. In some embodiments, attributes of automated-origin content request activity include a number of page views in a particular period of time. In some embodiments, attributes of automated-origin content request activity include pre-fetching of content in advance of a user request.

In some embodiments, the building the statistical profile of attributes of automated content request activity further includes generating the attributes of automated-origin content request activity by characterizing a plurality of content requests arriving from a list of known non-automated sources. In some embodiments, the building the statistical profile describing attributes of automated-origin content request activity for a network content provider further comprises assigning weights to respective attributes based on correlation strength, and the scoring a plurality of content requests of unknown origin in terms of similarity to the attributes further comprises applying the weights.

Some embodiments further support periodically updating attributes of automated-origin content request activity by scoring a plurality of content requests arriving from automated sources identified after the building the statistical profile describing attributes of automated-origin content request activity for a network content provider. Additionally, some embodiments further support periodically updating attributes of automated-origin content request activity by characterizing using a logistical regression approach a plurality of content requests arriving from automated sources identified after the building the statistical profile describing attributes of automated-origin content request activity for a network content provider. Some embodiments further support periodically updating attributes of automated-origin content request activity by characterizing using a neural networks approach a plurality of content requests arriving from automated sources identified after the building the statistical profile describing attributes of automated-origin content request activity for a network content provider.

Some embodiments may include a means for accessing or loading data indicative of network activity for analysis. For example, a network activity filtering module may receive input describing the network activity for the network content provider, and may build a statistical profile describing attributes of automated-origin content request activity for a network content provider, score a plurality of content requests of unknown origin in terms of similarity to the attributes, and indicate a likelihood of automated-origin content request activity based on the scoring is indicated, as described herein. The network activity filtering module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform building a statistical profile describing attributes of automated-origin content request activity for a network content provider, scoring a plurality of content requests of unknown origin is scored in terms of similarity to the attributes, and indicating a likelihood of automated-origin content request activity based on the scoring, as described herein. Other embodiments of the network activity filtering module may be at least partially implemented by hardware circuitry and/or firmware stored, for example, in a non-volatile memory.

### Systems for Bot Detection Using Profile-Based Filtering

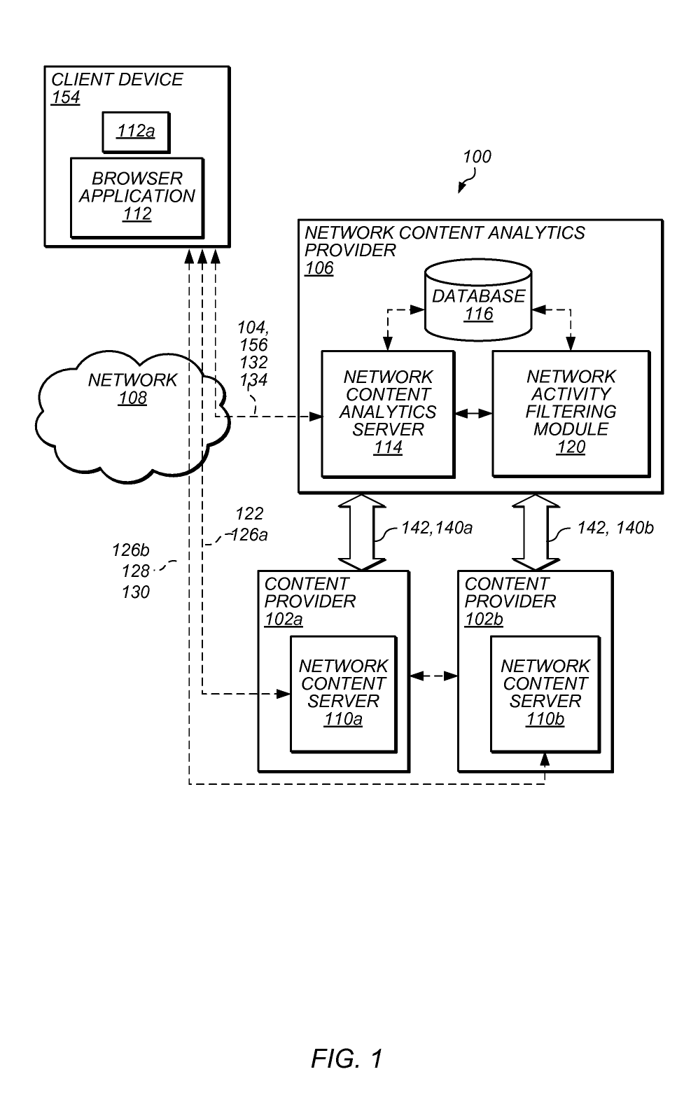

FIG. 1 illustrates an example network content analytics system configured to support-profile based network activity filtering in accordance with one or more other embodiments. A network content analytics system 100 in accordance with one or more embodiments may be employed to accumulate and/or process analytics data 104 representing various aspects of network activity used to assess an effectiveness of one or more items of network content. In the illustrated embodiment, system 100 includes content providers 102a and 102b hosting network content servers 110a and 110b, respectively, a client device 154 and a network content analytics provider 106.

Each of content providers 102a and 102b, client device 154 and network content analytics provider 106 may be communicatively coupled to one another via a network 108. Network 108 may include any channel for providing effective communication between each of the entities of system 100. In some embodiments, network 108 includes an electronic communication network, such as the internet, a local area network (LAN), a cellular communications network, or the like. Network 108 may include a single network or combination of networks that facilitate communication between each of the entities (e.g., content providers 102a and 102b, client device 154 and network content analytics provider 106) of system 100. Client device 154 may retrieve content from content providers 102a and/or 102b via network 108. Client device 154 may transmit corresponding analytics data 104 to network content analytics provider 106 via network 108. Network content analytics provider 106 may employ a network activity filtering module 120 to assess analytics data 104 and to perform building a statistical profile describing attributes of automated-origin content request activity for a network content provider, scoring a plurality of content requests of unknown origin in terms of similarity to the attributes, and indicating a likelihood of automated-origin content request activity based on the scoring, as described herein.

Content providers 102a and/or 102b may include source of information/content (e.g., an HTML file defining display information for a webpage) that is provided to client device 154. For example content providers 102a and/or 102b may include vendor websites used to present retail merchandise to a consumer. In some embodiments, content providers 102a and 102b may include respective network content servers 110a and 110b. Network content servers 110a and 110b may include web content 126a and 126b stored thereon, such as HTML files that are accessed and loaded by client device 154 for viewing webpages of content providers 102a and 102b. In some embodiments, content providers 102a and 102b may serve client device 154 directly. For example, content 126 may be provided from each of servers 110a or 110b directly to client device 154. In some embodiments, one of content providers 102a and 102b may act as a proxy for the other of content providers 102a and 102b. For example, server 110a may relay content from server 110b to client device 154.

Client device 154 may include a computer or similar device used to interact with content providers 102a and 102b. In some embodiments, client device 154 includes a wireless device used to access content 126a (e.g., web pages of a websites) from content providers 102a and 102b via network 108. For example, client device 154 may include a personal computer, a cellular phone, a personal digital assistant (PDA), or the like.

In some embodiments, client device 154 may include an application (e.g., internet web-browser application) 112 that can be used to generate a request for content, to render content, and/or to communicate request to various devices on the network. For example, upon selection of a website link on a webpage displayed to the user by browser application 112, browser application 112 may submit a request for the corresponding webpage/content to web content server 110a, and web content server 110a may provide corresponding content 126a, including an HTML file, that is executed by browser application 112 to render the requested website for display to the user. In some instances, execution of the HTML file may cause browser application 112 to generate additional requests for additional content (e.g., an image referenced in the HTML file as discussed below) from a remote location, such as content providers 102a and 102b and/or network content analytics provider 106. The resulting webpage 112a may be viewed by a user via a video monitor or similar graphical presentation device of client device 154.

While webpage 112a is discussed as an example of the network content available for use with the embodiments described herein, one of skill in the art will readily realize that other forms of content, such as audio or moving image video files, may be used without departing from the scope and content herein disclosed. Likewise, while references herein to HTML and the HTTP protocol are discussed as an example of the languages and protocols available for use with the embodiments described herein, one of skill in the art will readily realize that other forms of languages and protocols, such as XML or FTP may be used without departing from the scope and content herein disclosed.

Network analytics provider 106 may include a system for the collection and processing of analytics data 104, and the generation of corresponding metrics (e.g., hits, page views, visits, sessions, downloads, first visits, first sessions, visitors, unique visitors, unique users, repeat visitors, new visitors, impressions, singletons, bounce rates, exit percentages, visibility time, session duration, page view duration, time on page, active time, engagement time, page depth, page views per session, frequency, session per unique, click path, click, site overlay) web analytics reports including various metrics of the web analytics data (e.g., a promotion effectiveness index and/or a promotion effectiveness ranking) Analytics data 104 may include data that describes usage and visitation patterns for websites and/or individual webpages within the website. Analytics data 104 may include information relating to the activity and interactions of one or more users with a given website or webpage. For example, analytics data 104 may include historic and/or current website browsing information for one or more website visitors, including, but not limited to identification of links selected, identification of web pages viewed, identification of conversions (e.g., desired actions taken—such as the purchase of an item), number of purchases, value of purchases, and other data that may help gauge user interactions with webpages/websites.

Some embodiments of network activity filtering module 120 inform network content analytics server 114 whether a particular request or a group of requests from a client device 154 is human-generated (e.g., from a user requesting access to the content for a commercial transaction) or machine generated (e.g., an automated request for spidering or spying) and thereby improve the degree to which analytics data 104 include relating to the activity and interactions of one or more actual users (as opposed to bots) with a given website or webpage.

In some embodiments, analytics data 104 includes information indicative of a location. For example analytics data may include location data 108 indicative of a geographic location of client device 154. In some embodiments, location data 108 may be correlated with corresponding user activity. For example, a set of received analytics data 104 may include information regarding a user's interaction with a web page (e.g., activity data) and corresponding location data indicative of a location of client device 154 at the time of the activity. Thus, in some embodiments, analytics data 104 can be used to assess a user's activity and the corresponding location of the user during the activities. In some embodiments, location data includes geographic location information. For example, location data may include an indication of the geographic coordinates (e.g., latitude and longitude coordinates), IP address or the like or a user or a device.

Network activity filtering module 120 may be used to implement bot detection using profile-based filtration are described below in the example context of use in network analytics. In some embodiments, network activity filtering module 120 builds a statistical profile describing attributes of automated-origin content request activity for a network content provider. Examples of such attributes include information such as a type of a connection between client device 154 and network 108, browser height/width of browser application 112, referring URL that pointed browser 112s to a web page 112a, current URL of page 112a, time/date of request by client device 154, whether Java is enabled on browser application 154, a JavaScript version on browser application 154, a visitorlD for client device 154, monitor depth for client device 154, browser plugins for browser 112, whether cookies are enabled on browser 112, IP address of client device 154, domain of client device 154, user agent string on client device 154, language used on client device 154, cookies present on client device 154, and other similar items.

In some embodiments, network activity filtering module 120 scores a plurality of content requests of unknown origin in terms of similarity to the attributes, and a sample of the content requests selected as having a low likelihood of automated-origin content request activity based on the scoring is designated. Thus, some embodiments of network activity filtering module 120 inform network content analytics server 114 whether a particular request or a group of requests from a client device 154 is human-generated (e.g., from a user requesting access to the content for a commercial transaction) or machine generated (e.g., an automated request for spidering or spying).

In some embodiments, network activity filtering module 120 filters plurality of content requests of unknown origin to eliminate ones of the plurality of content requests of unknown origin arriving from a list of known automated sources (e.g., from a list of known bots performing automated functions such as spidering or nefarious activities such as denial of service attacks or various forms of unauthorized automated information gathering). In some embodiments, network activity filtering module 120 builds the statistical profile of attributes of automated content request activity by generating the attributes of automated-origin content request activity by characterizing a plurality of content requests arriving from a list of known automated sources.

In some embodiments, upon receipt of each image request, network activity filtering module 120 performs a two step filtration process before processing of an image request by network content analytics server 114. First, network activity filtering module 120 matches a user agent string for client device 154 against a known list of bots. In the event of a match we see a match, the traffic is identified as a bot and is excluded. Second, network activity filtering module 120 scores the image request on its likelihood to of being a bot using a logistic regression model that includes previously identified variables and variable value weights.

Additionally, in some embodiments, the building the statistical profile of attributes of automated content request activity further includes generating the attributes of automated-origin content request activity by characterizing a plurality of content requests arriving from a list of known automated sources for common attributes. In some embodiments, the building the statistical profile of attributes of automated content request activity further includes generating the attributes of automated-origin content request activity by characterizing a plurality of content requests arriving from a list of known automated sources for attributes dissimilar from attributes of known non-automated content request activity.

An example of such a profile is described below.

In one embodiment, network activity filtering module 120 builds a statistical profile of attributes of automated content request activity in which the following variables and associated confidence and tolerance intervals are shown to be statistically significant and predictive of whether or not an image request is from a bot or human. Building the statistical profile of attributes of automated content request activity includes identifying thresholds based upon confidence intervals from the mean and then included tolerance intervals to show what range 99.7% of the population falls into. As used herein, a confidence interval denotes an interval used to indicate the reliability of an estimate (e.g., how likely the interval is to contain the parameter, which is qualified by a confidence level (α=90%, 95%, 99%)). An example of such a confidence interval gives a user the ability to say, “We are 95% confident that the population mean number of instances for Bots lie between 129 and 256.”

As used herein, a tolerance interval denotes an interval that one can claim contains at least a specified proportion with a specified degree of confidence—essentially, a confidence interval for a population proportion, rather than the mean or standard deviation. An example of such a tolerance interval gives a user the ability to say, “We are 95% confident that at least 99.7% of the population instances for Bots lie between −2,112 and 2,497.” In one embodiment, the following parameters were found significant:

### Instances (Bots)

Confidence Intervals [129, 256], α=0.95
Tolerance Intervals [−2112, 2497], α=0.95, p=0.997

### Instances (Humans)

Confidence Intervals [14, 52], α=0.95
Tolerance Intervals [−639, 704], α=0.95, p=0.997

### Post-Browser Width (Bots)

Confidence Intervals [700, 827], α=0.95
Tolerance Intervals [−1509, 3036], α=0.95, p=0.997

### Post-Browser Width (Humans)

Confidence Intervals [1145, 1204], α=0.95
Tolerance Intervals [−140, 2209], α=0.95, p=0.997

### Connection Types (Bots)

Confidence Intervals [0.38, 0.49], α=0.95, p=0.44 . . . KNOWN
Confidence Intervals [0.51, 0.60], α=0.95, p=0.56 . . . UNKNOWN

### Connection Types (Humans)

Confidence Intervals [0.54, 0.62], α=0.95, p=0.58 . . . KNOWN
Confidence Intervals [0.38, 0.46], α=0.95, p=0.41 . . . UNKNOWN

Some embodiments further support generating analytics reports, either in network activity filter module 120 or in network content analytics server 114, describing features of the sample of the content requests selected as having the low likelihood of automated-origin content request activity based on the scoring. In some embodiments, attributes of automated-origin content request activity include a number of page views in a particular period of time. In some embodiments, attributes of automated-origin content request activity include pre-fetching of content in advance of a user request.

In some embodiments, network activity filter module 120 builds the statistical profile of attributes of automated content request activity further by generating the attributes of automated-origin content request activity by scoring a plurality of content requests arriving from a list of known non-automated sources. In some embodiments, network activity filter module 120 builds the statistical profile describing attributes of automated-origin content request activity for a network content provider further by assigning weights to respective attributes based on correlation strength, and the scoring a plurality of content requests of unknown origin in terms of similarity to the attributes further comprises applying the weights.

Some embodiments further support network activity filter module 120 periodically updating attributes of automated-origin content request activity by characterizing a plurality of content requests arriving from automated sources identified after the building the statistical profile describing attributes of automated-origin content request activity for a network content provider. Additionally, some embodiments further support network activity filter module 120 periodically updating attributes of automated-origin content request activity by characterizing using a logistical regression approach a plurality of content requests arriving from automated sources identified after the building the statistical profile describing attributes of automated-origin content request activity for a network content provider. Some embodiments further support network activity filter module 120 periodically updating attributes of automated-origin content request activity by characterizing using a neural networks approach a plurality of content requests arriving from automated sources identified after the building the statistical profile describing attributes of automated-origin content request activity for a network content provider.

In some embodiments, analytics data 104 is accumulated over time to generate a set of analytics data (e.g., an analytics dataset) that is representative of activity and interactions of one or more users with a given website or webpage. For example, an analytics dataset may include analytics data associated with all user visits to a given website. Analytics data may be processed to generate metric values that are indicative of a particular trait or characteristic of the data (e.g., a number of website visits, a number of items purchased, value of items purchased, a conversion rate, a promotion effectiveness index, etc.).

Network content analytics provider 106 may include a third-party website traffic statistic service. Network content analytics provider 106 may include an entity that is physically separate from content providers 102a and 102b. Network content analytics provider 106 may reside on a different network location from content providers 102a and 102b and/or client device 154. In the illustrated embodiment, for example, network content analytics provider 106 is communicatively coupled to client device 154 via network 108. Network content analytics provider 106 may be communicatively coupled to content providers 102a and 102b via network 108. Network content analytics provider 106 may receive analytics data 104 from client device 154 via network 108 and may provide corresponding analytics data (e.g., web analytics reports) to content provider 102a and 102b or to network activity analytics module 220 via network 108 or some other form of communication.

In the illustrated embodiment, network activity analytics provider 106 includes a network content analytics server 114, a network content analytics database 116, and a network activity filtering module 120. In some embodiments, network activity filtering module 120 may include computer executable code (e.g., executable software modules) stored on a computer readable storage medium that is executable by a computer to provide associated processing. For example, network activity filtering module 120 may process web analytics datasets stored in database 116 to generate corresponding web analytics reports that are provided to content providers 102a and 102b. Accordingly, network activity filtering module 120 may assess analytics data 104 to assess an effectiveness of one or more promotions and perform the trend ascertainment and predictive functions described herein after filtering as described herein is performed by network activity filtering module.

Network content analytics server 114 may service requests from one or more clients. For example, upon loading/rendering of a webpage 112a by browser 112 of client device 154, browser 112 may generate a request to network content analytics server 114 via network 108. Network content analytics server 114 may process the request and return appropriate content (e.g., an image) 156 to browser 112 of client device 154. In some embodiments, the request includes a request for an image, and network content analytics provider 106 simply returns a single transparent pixel for display by browser 112 of client device 154, thereby fulfilling the request. The request itself may also include web analytics data embedded therein. Some embodiments may include content provider 102a and/or 102b embedding or otherwise providing a pointer to a resource, known as a “web bug”, within the HTML code of the webpage 112a provided to client device 154. The resource may be invisible a user, such as a transparent one-pixel image for display in a web page. The pointer may direct browser 112 of client device 154 to request the resource from network content analytics server 114. Network content analytics server 114 may record the request and any additional information associated with the request (e.g., the date and time, and/or identifying information that may be encoded in the resource request).

In some embodiments, an image request embedded in the HTML code of the webpage may include codes/strings that are indicative of web analytics data, such as data about a user/client, the user's computer, the content of the webpage, or any other web analytics data that is accessible and of interest. A request for an image may include, for example, “image.gif/XXX . . . ” wherein the string “XXX . . . ” is indicative of the analytics data 104. For example, the string “XXX” may include information regarding user interaction with a website (e.g., activity data) .

Network content analytics provider 106 may parse the request (e.g., at network content analytics server 114 or network activity filtering module 120) to extract the web analytics data contained within the request. Analytics data 104, both before and after profile based filtering by network activity filtering module 120, may be stored in database 116, or a similar storage/memory device, in association with other accumulated web analytics data. In some embodiments, network activity filtering module 120 may receive/retrieve analytics data from network content analytics server 114 and/or database 116. For example, network content analytics server 114 may provide raw web analytics data received at network content analytics server 114 to be filtered by network activity filter module 120 prior to use by network content analytics server 114 in generating trends and predictions analytics reports, as may be requested by a website administrator of one of content providers 102a and 102b. Reports, for example, may include overviews and statistical analyses describing the relative frequency with which various site paths are being followed through the content provider's website, the rate of converting a website visit to a purchase (e.g., conversion), an effectiveness of various promotions, and so forth, and identifying trends in and making predictions from the data as requested.

In some embodiments, client device 154 executes a software application, such as browser application 112, for accessing and displaying one or more webpages 112a. In response to a user command, such as clicking on a link or typing in a uniform resource locator (URL), browser application 112 may issue a webpage request 122 to web content server 110a of content provider 102a via network 108 (e.g., via the Internet). In response to request 122, web content server 110a may transmit the corresponding content 126a (e.g., webpage HTML code corresponding to webpage 112a) to browser application 112. Browser application 112 may interpret the received webpage code to display the requested webpage 112a at a user interface (e.g., monitor) of client 154. Browser application 112 may generate additional requests for content from the servers, or other remote network locations, as needed. For example, if webpage code calls for content, such as an advertisement, to be provided by content provider 102b, browser application 112 may issue an additional request 130 to web content server 110b. Web content server 110b may provide a corresponding response 128 containing requested content, thereby fulfilling the request. Browser application 112 may assemble the additional content for display within webpage 112a.

In some embodiments, client device 154 also transmits webpage visitation tracking information to web analytics provider 106. For example, as described above, webpage code may include executable code (e.g., a web bug) to initiate a request for data from network content analytics server 114 such that execution of webpage code at browser 112 causes browser 112 to generate a corresponding request (e.g., a web-beacon request) 132 for the data to web analytics server 114. In some embodiments, request 132 may itself have analytics data (e.g., analytics data 104) contained/embedded therein, or otherwise associated therewith, such that transmitting request 132 causes transmission of analytics data from client 154 to web analytics provider 106. For example, as described above, request 132 may include an image request having an embedded string of data therein. Network content analytics provider 106 may process (e.g., parse) request 132 to extract analytics data 104 contained in, or associated with, request 132.

In some embodiments, request 132 from client 154 may be forwarded from network content analytics server 114 to database 116 for storage and/or to network activity filtering module 120 for processing. Network activity filtering module 120 and/or network content analytics server 114 may process the received request to extract web analytics data 104 from request 132. Where request 132 includes a request for an image, network content analytics server 114 may simply return content/image 134 (e.g., a single transparent pixel) to browser 112, thereby fulfilling request 128. In some embodiments, network content analytics provider 106 may transmit analytics data (e.g., analytics data 104) and/or a corresponding analytics reports to content providers 102a and/or 102b, or other interested entities.

For example, analytics data and/or web analytics reports 140a and 140b (e.g., including processed web analytics data) may be forwarded to site administrators of content providers 102a and 102b via network 108, or other forms of communication. In some embodiments, a content provider may log-in to a website, or other network based application, hosted by network content analytics provider 106, and may interact with network activity filtering module 120 or network content analytics server to generate custom web analytics reports. For example, content provider 102a may log into a web analytics website via website server 114, and may interactively submit request 142 to generate reports from network activity filtering module 120 for various metrics (e.g., number of conversions for male users that visit the home page of the content provider's website, an effectiveness of a promotion, etc.), and network analytics provider 106 may return corresponding reports (e.g., reports dynamically generated via corresponding queries for data stored in database 116 and processing of the network activity filtering module 120). In some embodiments, content providers 102a and 102b may provide analytics data to web analytics provider 106. In some embodiments, reports may include one or more metric values that are indicative of a characteristic/trait of a set of data or may include trends and prediction reporting and graphical displays as described herein.

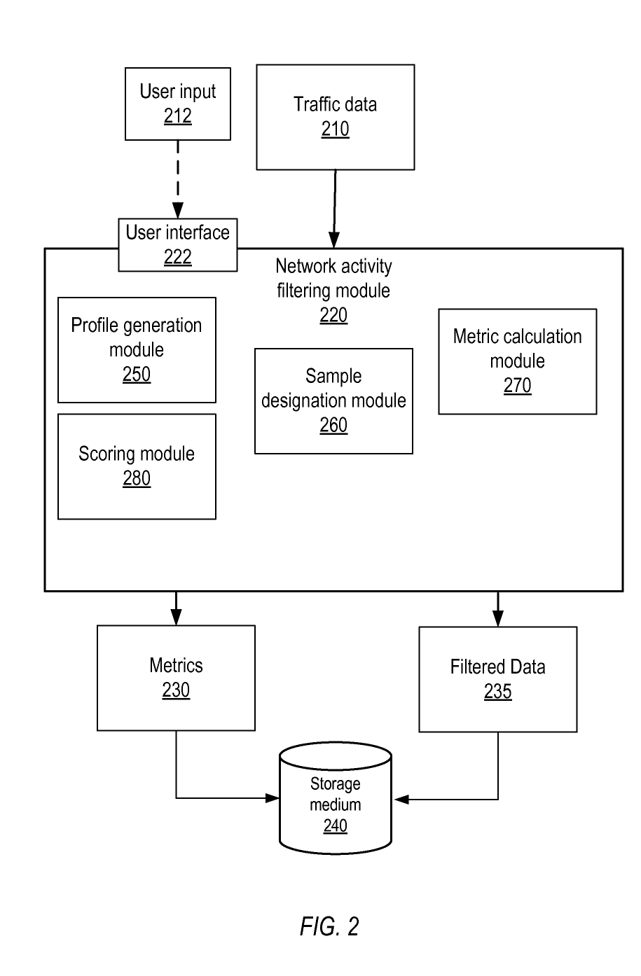

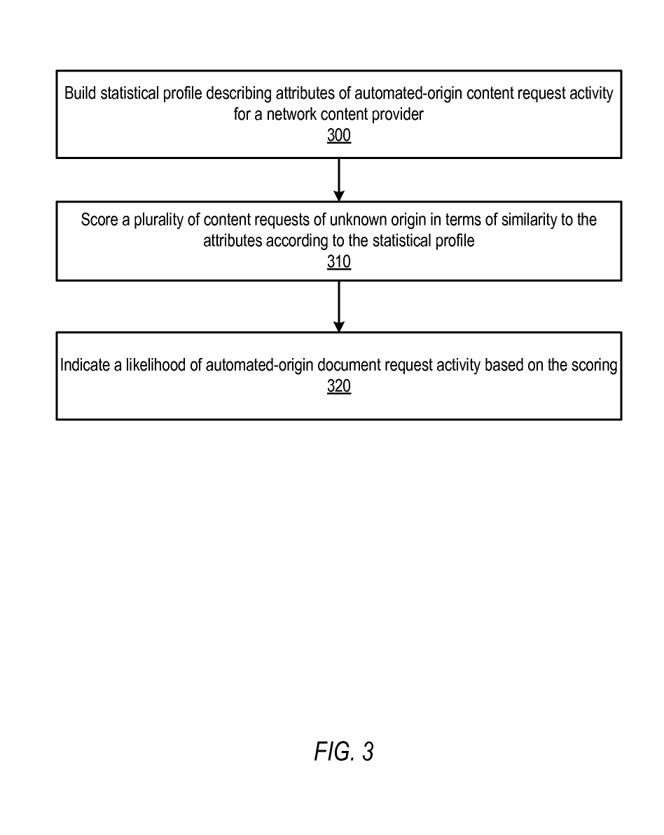

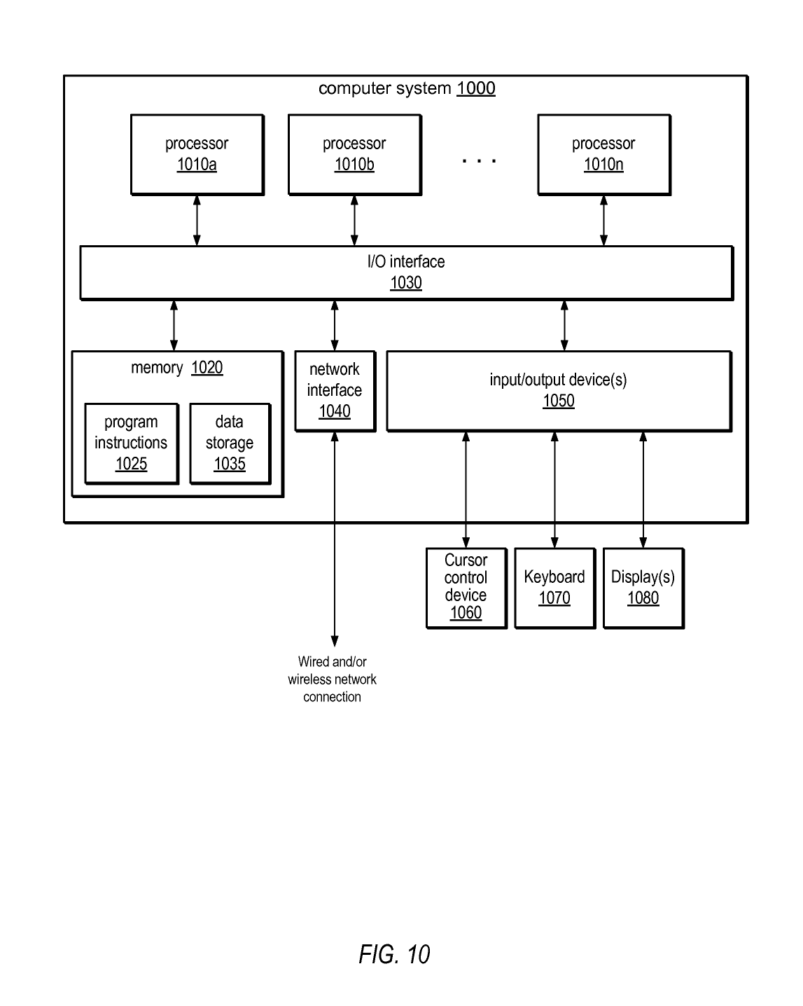

FIG. 2 depicts a module that may implement bot detection using profile-based filtration, according to some embodiments. Network activity filtering module 220 may, for example, implement one or more of a filtering tool, a profile building tool, and a traffic scoring tool, for performing the functions described herein with respect to FIGS. 3-9. FIG. 10 illustrates an example computer system on which embodiments of network activity filtering module 220 may be implemented. Network activity filtering module 220 receives as input traffic data 210, as discussed above. Network activity filtering module 220 may receive user input 212 activating a filtering tool, a profile building tool, and a traffic scoring tool, for performing the functions described herein with respect to FIGS. 3-9. Network activity filtering module 220 then performs the functions described herein with respect to FIGS. 3-9 on the traffic data 210, according to user input 212 received via user interface 222. The user may then activate a tool and further generate analysis of trends, analysis of relationships, or analysis of predictions. Network activity filtering module 220 generates as output one or more of filtered data 235, as well as one or more sets of metrics 230. Filtered data 235 and metrics 230 may, for example, be stored to a storage medium 240, such as system memory, a disk drive, DVD, CD, etc.

In some embodiments, network activity filtering module 220 may provide a user interface 222 via which a user may interact with network activity filtering module 220, for example to activate a activate traffic filtering tool, configure tolerances, set confidence intervals, and control traffic flows analyzed. In some embodiments, user interface 222 may provide user interface elements, such as dropdown boxes, whereby the user may select options including, but not limited to, variable values, traffic flows filtered, and other settings.

A profile generation module 250 performs building a statistical profile describing attributes of automated-origin content request activity for a network content provider. A sample designation module 260 performs indicating a likelihood of automated-origin content request activity based on the scoring. A metric calculation module 270 performs generating analytics reports describing features of the sample of the content requests selected as having the low likelihood of automated-origin content request activity based on the scoring. A scoring module 280 performs scoring a plurality of content requests of unknown origin in terms of similarity to the attributes.

### Operations for Implementing Bot Detection Using Profile-Based Filtering

FIG. 3 illustrates a high-level logical flowchart of operations performed to implement one embodiment of bot detection using profile-based filtration, according to some embodiments. A statistical profile describing attributes of automated-origin content request activity for a network content provider is built (block 300). A plurality of content requests of unknown origin is scored in terms of similarity to the attributes (block 310). A likelihood of automated-origin content request activity based on the scoring is indicated (block 320).

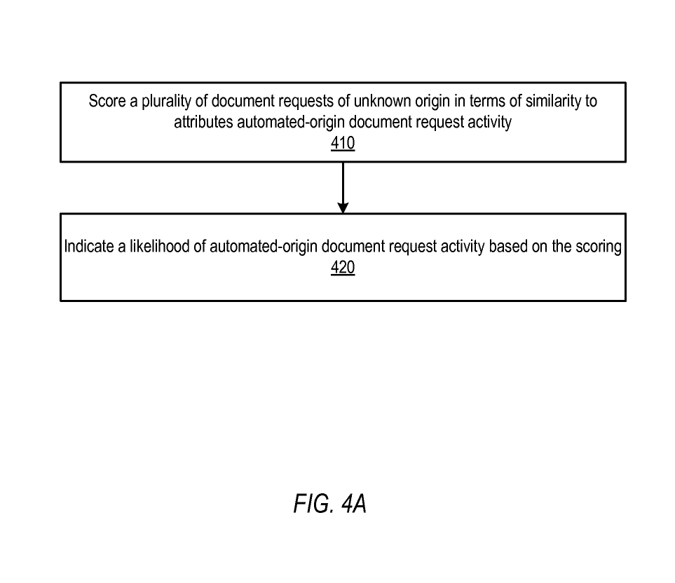

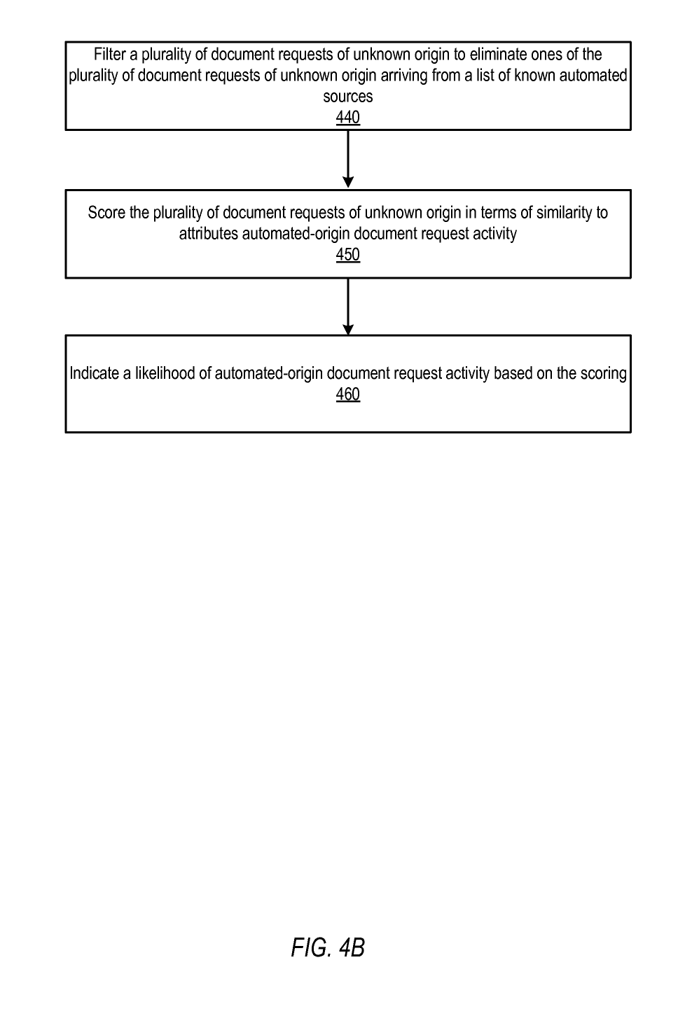

FIG. 4A depicts a high-level logical flowchart of run-time operations performed to implement one embodiment of bot detection using profile-based filtration, according to some embodiments. A plurality of content requests of unknown origin is scored in terms of similarity to attributes automated-origin content request activity (block 410). A likelihood of automated-origin content request activity based on the scoring is indicated (block 420).

FIG. 4B illustrates a high-level logical flowchart of runtime operations performed to implement one embodiment of bot detection using list and profile-based filtration, according to some embodiments. A plurality of content requests of unknown origin is filtered to eliminate ones of the plurality of content requests of unknown origin arriving from a list of known automated sources (block 440). The plurality of content requests of unknown origin is scored in terms of similarity to attributes automated-origin content request activity (block 450). A likelihood of automated-origin content request activity based on the scoring is indicated (block 460).

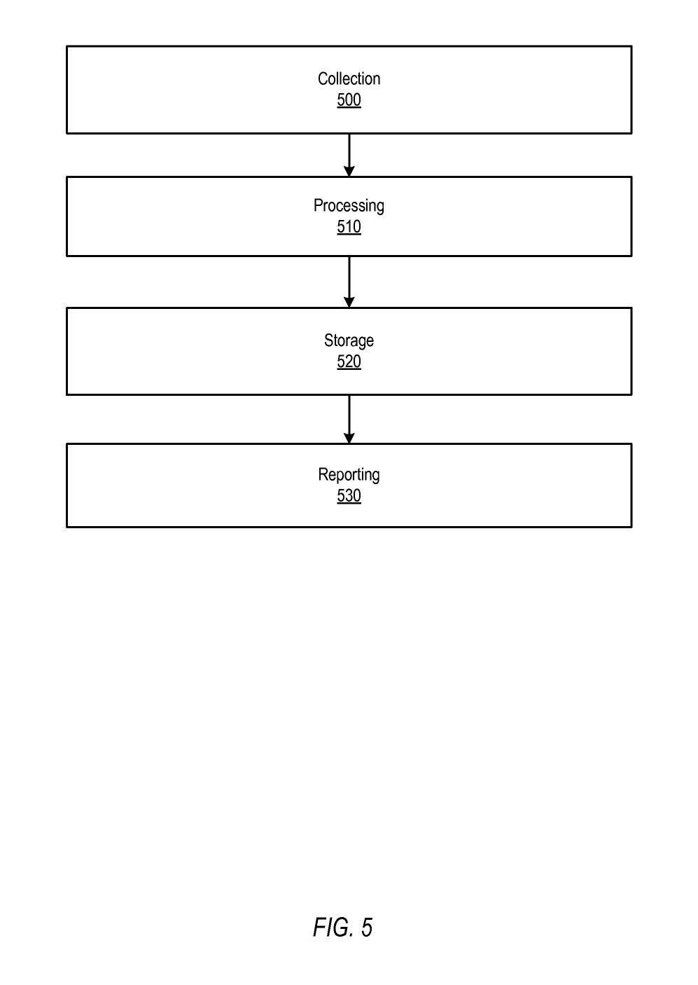

FIG. 5 depicts a high-level logical flowchart of operations performed to implement one embodiment of processing of network analytics using profile-based filtration, according to some embodiments. A collection function is performed (block 500). In some embodiments, the collection function includes receipt of network traffic data. A processing function is performed (block 510). In some embodiments, the processing function includes profile-based filtering as discussed herein. A storage function is performed. (block 520). In some embodiments, the storage function includes

assignment of data to a database, as described herein. A reporting function is performed (block 530). In some embodiments, the reporting function includes the reporting of metrics as described herein.

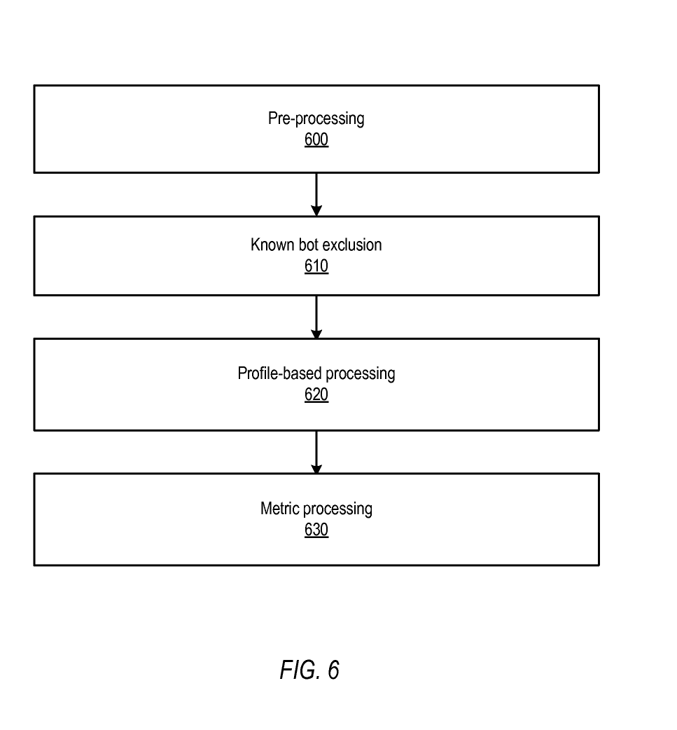

FIG. 6 illustrates a high-level logical flowchart of operations performed to implement one embodiment of bot detection using list and profile-based filtration, according to some embodiments. A pre-processing function is performed (block 600). In some embodiments, the pre-processing function includes categorization and formatting of data. Known bot exclusion, using a bot list, is performed, as described herein (block 610). Profile-based processing is performed, as described herein (block 620). Metric processing is performed (block 630).

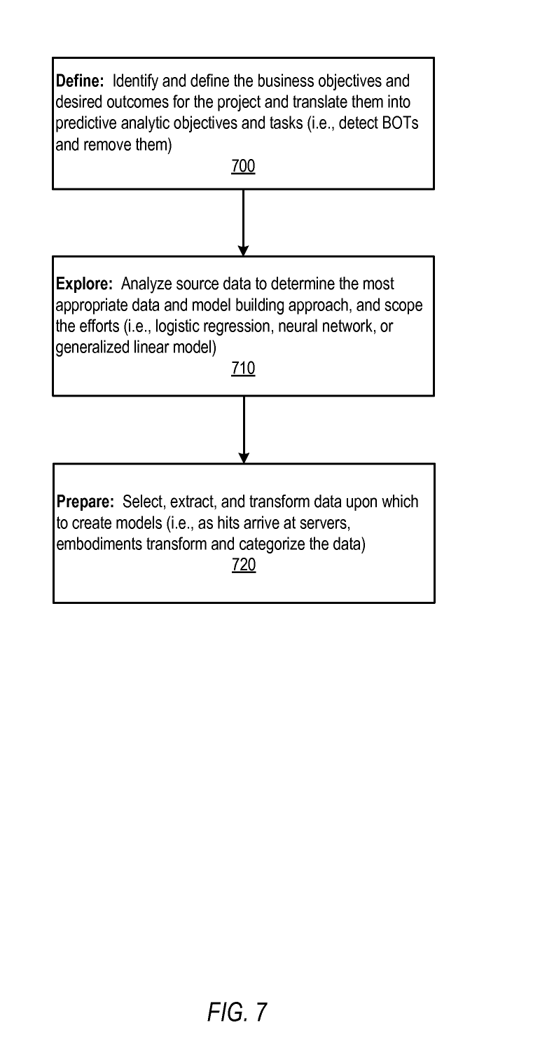

FIG. 7 depicts a high-level logical flowchart of operations performed to implement a process flow for bot detection using profile-based filtration, according to some embodiments. Business objectives and desired outcomes for a project are identified and translated into predictive analytic objectives and tasks (i.e., detect BOTs and remove them) (block 700). Source data is analyzed to determine the most appropriate data and model building approach, and scope the efforts (i.e., logistic regression, neural network, or generalized linear model) (block 710). Data upon which to create models is selected, extracted and transformed (i.e., as hits arrive at servers, embodiments transform and categorize the data) (block 720).

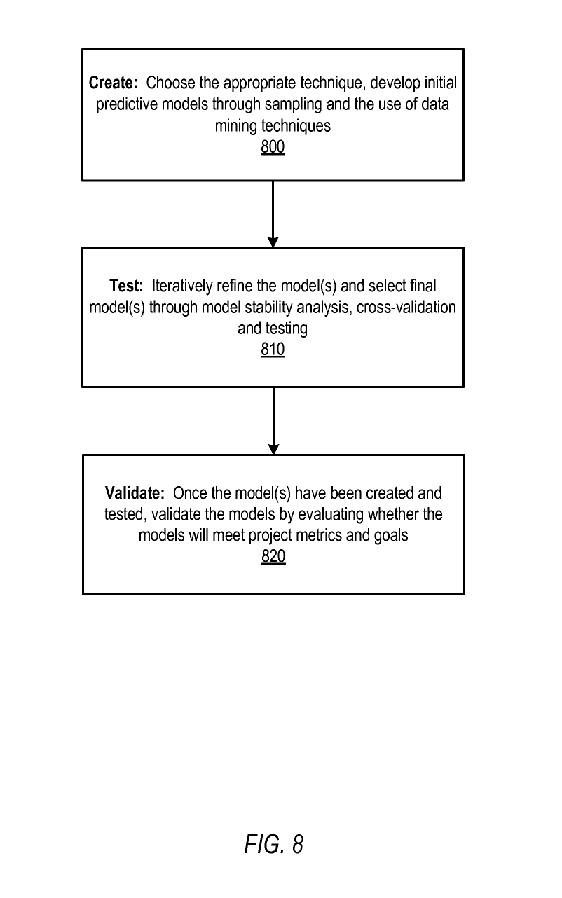

FIG. 8 illustrates a high-level logical flowchart of operations performed to implement a process flow for bot detection using profile-based filtration, according to some embodiments. An appropriate technique is chosen, and initial predictive models are developed through sampling and the use of data mining techniques (block 800). The model(s) are iteratively refined and final model(s) are selected through model stability analysis, cross-validation and testing (block 810). Once the model(s) have been created and tested, the models are validated by evaluating whether the models will meet project metrics and goals (block 820).

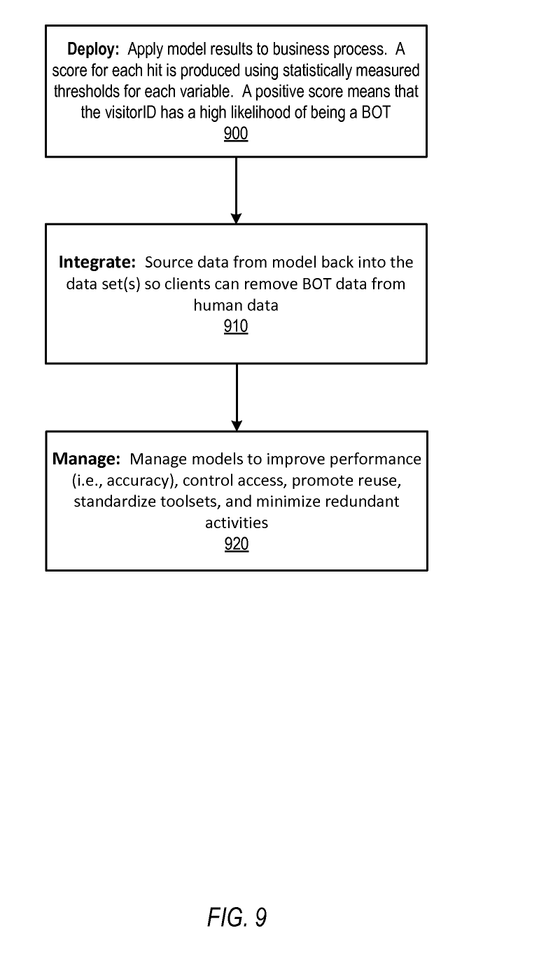

FIG. 9 depicts a high-level logical flowchart of operations performed to implement a process flow for bot detection using profile-based filtration, according to some embodiments. Model results are applied to a business process. (block 900). A score for each hit is produced using statistically measured thresholds for each variable. A positive score means that the visitorlD has a high likelihood of being a bot. Source data is integrated from model back into the data set(s) so clients can remove bot data from human data (block 910). Models are managed to improve performance (i.e., accuracy), control access, promote reuse, standardize toolsets, and minimize redundant activities (block 920).

### EXAMPLE SYSTEM

Embodiments of a network activity filtering module and/or of the various network activity filtering techniques as described herein may be executed on one or more computer systems, which may interact with various other devices. One such computer system is illustrated by FIG. 10. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a network activity analytics analysis module are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 10, memory 1020 may include program instructions 1025, configured to implement embodiments of a network activity filtering module as described herein, and data storage 1035, comprising various data accessible by program instructions 1025. In one embodiment, program instructions 1025 may include software elements of embodiments of a network activity analytics analysis module as illustrated in the above Figures. Data storage 1035 may include data that may be used in embodiments. In other embodiments, other or different software elements and data may be included.

Those skilled in the art will appreciate that computer system 1000 is merely illustrative and is not intended to limit the scope of a network activity analytics analysis module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method, comprising:
building a statistical profile describing attributes of automated-origin content request activity for a network content provider;
scoring a plurality of content requests of unknown origin in terms of similarity to the attributes according to the statistical profile; and
indicating a likelihood of automated-origin content request activity based on the scoring.

2. The method of claim 1, further comprising,
prior to the scoring, filtering the plurality of content requests of unknown origin to eliminate from said scoring ones of the plurality of content requests of unknown origin arriving from a list of known automated sources.

3. The method of claim 1, wherein,
the building the statistical profile of attributes of automated content request activity further comprises characterizing a plurality of content requests arriving from a list of known automated sources.

4. The method of claim 3,
the building the statistical profile of attributes of automated content request activity further comprises characterizing a plurality of content requests arriving from a list of known automated sources for common attributes.

5. The method of claim 3,
the building the statistical profile of attributes of automated content request activity further comprises characterizing a plurality of content requests arriving from a list of known automated sources for attributes dissimilar from attributes of known non-automated content request activity.

6. The method of claim 1, further comprising:
generating analytics reports describing features of a set of content requests selected to exclude content requests having a high likelihood of automated-origin content request activity.

7. The method of claim 1, wherein
attributes of automated-origin content request activity comprise a number of page views in a particular period of time.

8. The method of claim 1, wherein
attributes of automated-origin content request activity comprise pre-fetching of content in advance of a user request.

9. The method of claim 1, wherein,
the building the statistical profile of attributes of automated content request activity further comprises characterizing a plurality of content requests arriving from a list of known non-automated sources.

10. The method of claim 1, wherein
the building the statistical profile describing attributes of automated-origin content request activity for a network content provider further comprises assigning weights to respective attributes based on relative correlation strength between a value of an attribute and a likelihood of automated activity; and
the scoring a plurality of content requests of unknown origin in terms of similarity to the attributes further comprises applying the weights.

11. The method of claim 1, wherein
the method further comprises updating attributes of automated-origin content request activity by scoring a plurality of content requests arriving from automated sources identified after the building the statistical profile.

12. The method of claim 1, wherein
the method further comprises updating attributes of automated-origin content request activity by scoring using a logistical regression approach.

13. The method of claim 1, wherein
the method further comprises updating attributes of automated-origin content request activity by scoring using a neural networks approach.

14. A non-transitory computer-readable storage medium storing program instructions, wherein the program instructions are computer-executable to implement:
building a statistical profile describing attributes of automated-origin content request activity for a network content provider;
scoring a plurality of content requests of unknown origin in terms of similarity to the attributes according to the statistical profile; and
indicating a likelihood of automated-origin content request activity based on the scoring.

15. The non-transitory computer-readable storage medium of claim 14, further comprising program instructions computer-executable to implement:
filtering the plurality of content requests of unknown origin to eliminate from the scoring ones of the plurality of content requests of unknown origin arriving from a list of known automated sources.

16. The non-transitory computer-readable storage medium of claim 14, wherein:
the program instructions computer-executable to implement:
updating attributes of automated-origin content request activity by characterizing using a neural networks approach a plurality of content requests arriving from automated sources identified after the building the statistical profile.

17. A system, comprising:
at least one processor; and
a memory comprising program instructions, wherein the program instructions are executable by the at least one processor to:
build a statistical profile describing attributes of automated-origin content request activity for a network content provider;
score a plurality of content requests of unknown origin in terms of similarity to the attributes according to the statistical profile; and
designate a sample of the content requests selected as having a low likelihood of automated-origin content request activity based on the scoring.

18. The system of claim 17, further comprising program instructions executable by the at least one processor to:
filter the plurality of content requests of unknown origin to eliminate from the scoring ones of the plurality of content requests of unknown origin arriving from a list of known automated sources.

19. The system of claim 17, further comprising program instructions executable by the at least one processor to generate analytics reports describing features of the sample of the content requests selected as having a low likelihood of automated-origin content request activity based on the scoring.

20. The system of claim 17, further comprising program instructions executable by the at least one processor to:
update attributes of automated-origin content request activity by characterizing using a neural networks approach a plurality of content requests arriving from automated sources identified after the building the statistical profile.
